(19) United States
(12) Patent Application Publication
(10) Pub. No.: US 2005/0226459 A1
(43) Pub. Date: Oct. 13, 2005

(54) Vibrating plate for speaker and method of fabricating the same

(75) Inventors: Hiroyuki Tomiyama, Yamagata (JP); Yuichi Kasahara, Yamagata (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/077,385

(22) Filed: Mar. 11, 2005

(30) Foreign Application Priority Data
Mar. 12, 2004 (JP) P2004-069993

(51) Int. Cl. H04R 25/00

(52) U.S. Cl. 381/424; 381/398

(57) ABSTRACT

A vibrating plate for a speaker, includes: a magnesium vibrating plate whose major component is magnesium; and an edge comprising a resin in which an inner peripheral edge of the edge is bonded to an outer peripheral edge of the magnesium vibrating plate for attaching the magnesium vibrating plate to a frame, in which the inner peripheral edge of the edge is constituted by a structure having a pinching groove which the outer peripheral edge of the magnesium vibrating plate is brought into close contact with and fitted to, and the edge is formed integrally with the magnesium vibrating plate by insert molding.

### BACKGROUND OF THE INVENTION

1. Field of the Invention

The present invention relates to a vibrating plate for a speaker using a magnesium vibrating plate and a method of fabricating the same.

2. Description of the Related Art

According to a vibrating plate used in a speaker apparatus, generally, the higher the rigidity, the higher fh (high-path limit frequency) can be set, which is advantageous when sound is reproduced up to a high frequency band in a state of small distortion.

Hence, various vibrating plates using metal materials of aluminum, titanium and the like have been developed.

However, according to the metals, since an internal loss (tangentδ) is small, when fh is produced in an audible band up to 20 Hz through 20 KHz, in comparison with a resin species vibrating plate whose major component is a resin material of, for example, polyimide or the like, peak or dip significantly emerges at a high frequency band to bring about a sound quality conversely having large distortion.

Further, a specific weight of a metal material of aluminum, titanium or the like is larger than that of a resin material and therefore, there poses a problem that an efficiency of converting an input signal into an output sound pressure is lowered.

From such a background, attention has been attracted to a magnesium vibrating plate whose major component is magnesium more light-weighted than aluminum or titanium and capable of achieving a rigidity higher than that of a resin material as a metal species vibrating plate excellent in high-path reproduction (refer to, for example, JP-A-2002-369284).

Further, an explanation will be given of a structure of fixing a vibrating plate of a speaker apparatus of a general cone type to a frame in reference to FIG. 1 as follows.

FIG. 1 shows an example of bonding an edge 3 comprising a resin to an outer periphery of a vibrating plate 1.

The vibrating plate 1 shown in FIG. 1 is of a cone type. The edge 3 comprising the resin is constituted by a structure of extending flange portions 3b, 3c to respectives of an inner periphery and an outer periphery of a loop portion 3a for permitting to displace the vibrating plate 1, generally, bonded to the vibrating plate 1 by adhering the flange portion 3b constituting an inner peripheral edge to an outer peripheral edge of the vibrating plate 1 pertinently by an adhering agent. The flange portion 3c constituting the outer peripheral edge of the edge 3 is fixed to the flame of the speaker apparatus.

### SUMMARY OF THE INVENTION

In the case of using a magnesium vibrating plate by the vibrating plate of the cone type as shown by FIG. 1, when the edge 3 comprising a resin is bonded to the vibrating plate 1 by an adhering agent, after processing to adhere the edge 3, a volatile organic compound (VOC) of toluene or the like included in the adhering agent is evaporated and there is a concern of effecting an influence on an operator or contaminating environment.

Further, magnesium is liable to produce rust by being brought into contact with air and therefore, there is executed rust proofing for covering a surface of a thin film of magnesium constituting the material of the magnesium vibrating plate by a plated layer or an oxide film or the like.

Further, although an outer peripheral edge of the magnesium vibrating plate is cut to a predetermined dimension after having been formed in a predetermined cone shape, also a cut face of the outer periphery needs to be subjected to an end face processing with an object of rust proofing before adhering the edge 3 comprising a resin.

That is, when the magnesium vibrating plate has been finished to form in the predetermined cone shape and is prepared to the final dimension by cutting the outer peripheral edge, the cut face of the outer periphery needs to be subjected to the end face processing for rust proofing by bringing back the magnesium vibrating plate to a surface treatment step or the like again, even when the magnesium vibrating plate is prepared to the final dimension, the magnesium vibrating plate cannot be shifted to a step of bonding the edge and therefore, there poses a problem that productivity is poor.

As problems to be resolved by the invention, there are pointed out a problem caused in the above, that is, the problem that the volatile organic compound is evaporated and the problem that the magnesium vibrating plate cannot be shifted immediately to the step of bonding the edge even when the magnesium vibrating plate is prepared to the final dimension since the cut face of the outer periphery needs to be subjected to the end face processing for rust proofing and the productivity is poor, respectively as examples.

According to a first aspect of the invention, a vibrating plate for a speaker, includes: a magnesium vibrating plate whose major component is magnesium; and an edge comprising a resin in which an inner peripheral edge of the edge is bonded to an outer peripheral edge of the magnesium vibrating plate for attaching the magnesium vibrating plate to a frame, in which the inner peripheral edge of the edge is constituted by a structure having a pinching groove which the outer peripheral edge of the magnesium vibrating plate is brought into close contact with and fitted to, and the edge is formed integrally with the magnesium vibrating plate by insert molding.

According to a second aspect of the invention, a method for fabricating a vibrating plate for a speaker including a magnesium vibrating plate whose major component is magnesium; and an edge comprising a resin in which an inner peripheral edge of the edge is bonded to an outer peripheral edge of the magnesium vibrating plate for attaching the magnesium vibrating plate to a frame, includes: forming the edge integrally with the magnesium vibrating plate by insert molding, in which the inner peripheral edge of the edge is constituted by a structure having a pinching groove which the outer peripheral edge of the magnesium vibrating plate is brought into close contact with and fitted to.

### BRIEF DESCRIPTION OF THE DRAWINGS

FIG. 1 is a vertical sectional view for explaining a structure of fixing a vibrating plate in a speaker apparatus of a general cone type to a frame.

FIG. 2 is a vertical sectional view for explaining a first embodiment of the speaker apparatus using a vibrating plate for a speaker according to the invention.

FIG. 3 is an explanatory view of a method of fabricating the vibrating plate for a speaker shown in FIG. 2.

FIG. 4 is a vertical sectional view of other embodiment of a speaker apparatus using a vibrating plate for a speaker according to the invention.

FIG. 5 is an explanatory view of a method of fabricating the vibrating plate for a speaker shown in FIG. 4.

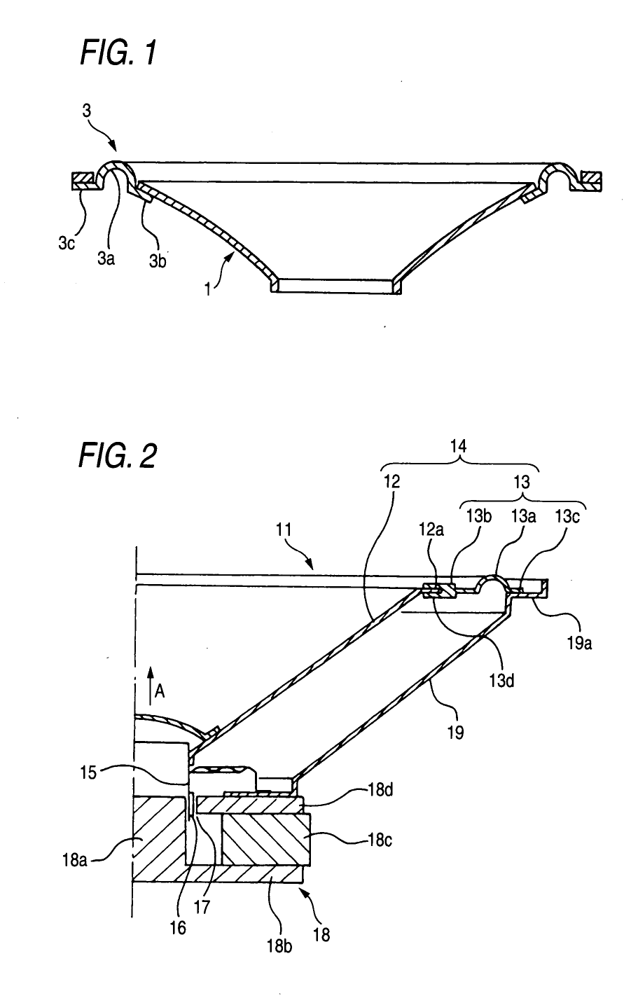

### DETAILED DESCRIPTION OF THE PREFFERED EMBODIMETNS

A detailed explanation will be given of embodiments of a vibrating plate for a speaker and a method of fabricating the same in reference to the drawings as follows.

### First Embodiment

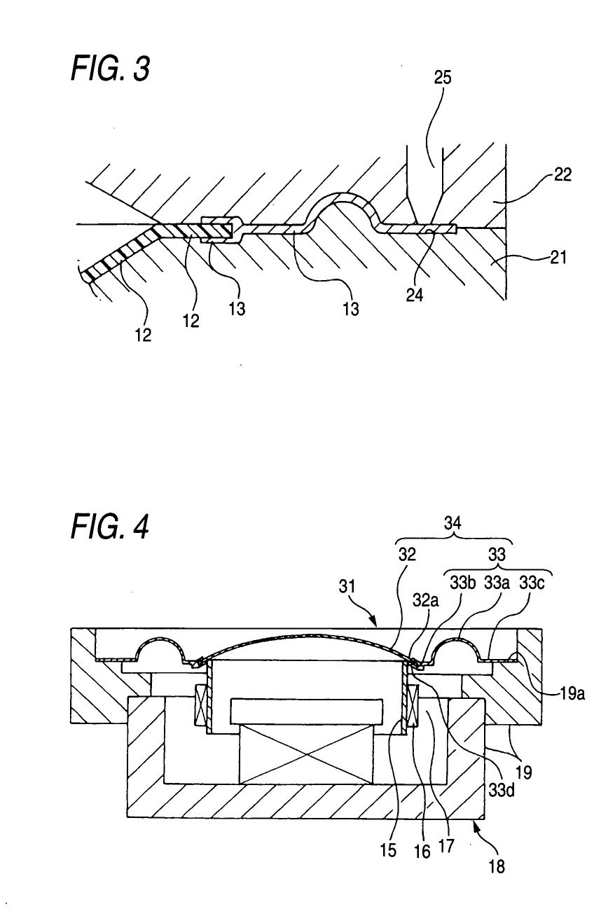

FIG. 2 is a vertical sectional view of a speaker apparatus using a vibrating plate for a speaker of a first embodiment according to the invention, and FIG. 3 shows a method of fabricating the vibrating plate for a speaker shown in FIG. 2.

A speaker apparatus 11 shown in FIG. 2 is provided with a vibrating plate 14 for a speaker bonding an edge 13 comprising a resin to an outer periphery of a magnesium vibrating plate 12 of a cone type, a voice coil bobbin 15 in a cylindrical shape connected to an inner peripheral edge of the vibrating plate 12, a voice coil 16 wound around an outer periphery of the voice coil bobbin 15, a magnetic circuit 18 formed with a magnetic gap 17 for containing the voice coil 16, and a flame 19 for supporting the magnetic circuit 18 and the vibrating plate 14.

According to the edge 13, an inner peripheral edge 13b extended to an inner diameter portion of a loop portion 13a constituting a damper for permitting an amplitude of the magnesium vibrating plate 12 constitutes a portion of bonding to an outer peripheral edge of the magnesium vibrating plate 12, and an outer peripheral edge 13c extended to a side of an outer diameter of the loop portion 13a is fixed to an edge supporting portion 19a of the flame 19.

The inner peripheral edge 13b of the edge 13 is constituted by a structure having a pinching groove 13d which the outer peripheral edge of the magnesium vibrating plate 12 is brought into close contact with and fitted to.

The edge 13 is molded in a predetermined shape by injection molding of a resin and at that occasion, as shown by FIG. 3, the edge 13 is formed integrally with the magnesium vibrating plate 12 by insert molding of constituting a state of holding the outer peripheral edge 12a of the magnesium vibrating plate 12 which has been cut to a predetermined dimension into a cavity 24 formed by upper and lower dies 21, 22 for molding the edge and injecting the resin into the cavity 24.

Notation 25 of FIG. 3 designates a runner (resin introducing port for guiding the resin into the cavity 24.

In the case of the embodiment, the magnesium vibrating plate 12 is delivered to a resin molding step of executing inert molding of the edge 13 after cutting the outer periphery to a predetermined dimension in a state of not subjecting a cut face of the outer periphery to an end face processing for rust proofing.

As a supplemental explanation, the magnesium vibrating plate 12 is formed with an anodized film dyed by a dyestuff at a surface thereof to promote rust proofing of magnesium and design performance after forming, for example, a magnesium thin plate as major component is magnesium into a predetermined cone shape.

The anodized film may be formed by anodizing by using an alkali mixed aqueous solution having pH equal to or lager than 12 including a metal salt and a thickness dimension thereof may be constituted to be equal to or larger than 0.1 μm and equal to or smaller than 3 μm.

An electrochemical deposition coating film may be provided on a surface of anodized film. The electrochemical deposition coating film is formed by using an electrochemical deposition coating whose major component is an acrylic species resin. A thickness dimension of the electrochemical deposition coating film may be set to be equal to or lager than 2 μm and equal to or smaller than 30 μm. By providing the electrochemical deposition coating film, color tone of the surface of the magnesium vibrating plate 12 can be finished by arbitrary color tone.

The magnesium thin plate constituting a raw material of the magnesium vibrating plate 12 may be formed to a final thickness (desired thickness) of 30 μm through 100 μm by repeating a processing of rolling a base material whose major component is magnesium in a heated state by a pertinent number of times.

The magnetic circuit 18 is constructed by a constitution having a center pole 18a in a shape of a circular column arranged at a back portion on a center axis of the magnesium vibrating plate 12, a first plate 18b formed by expanding an outer periphery of a base end of the center pole 18a in a flange-like shape, a magnet 18c in a ring-like shape arranged on the first plate 18b, and a second plate 18d in a ring-like shape covered on the magnet 18c to be opposed to the first plate 18b, and a gap between an inner peripheral face of the second plate 18d and an outer peripheral face of the center pole 18a constitutes a magnetic gap 17 for containing the voice coil 16.

The above-described magnetic circuit 18 forms a magnetic circuit of an external magnet type for concentrating a magnetic flux to the magnetic gap 17 and drives the voice coil 16 in a direction of a center axis shown by an arrow mark A in accordance with an electric signal inputted to the voice coil 16.

According to the vibrating plate 14 for a speaker and the method of fabricating the same explained as described above, bonding of the edge 13 comprising the resin to the outer peripheral edge of the magnesium vibrating plate 12 is realized by insert molding and an adhering agent is not used.

Therefore, there is not brought about a situation of evaporating a volatile organic compound in an adhering agent and an influence on an operator and contamination of an environment caused by evaporating the volatile organic compound can be prevented.

The inner peripheral edge 13b of the edge 13 bonded to the outer peripheral edge of the magnesium vibrating plate 12 by insert molding is constituted by a structure having the pinching groove 13d which the outer peripheral edge of the magnesium vibrating plate 12 is brought into close contact with and fitted to and the cut face of the outer periphery of the magnesium vibrating plate 12 is covered by the pinching groove 13d to prevent from being brought into contact with outer air for generating rust at the cut face.

Therefore, as described above, even when the edge 13 is bonded to the cut face of the outer periphery of the magnesium vibrating plate 12 by dispensing with an end face treatment for rust proofing, rust can be prevented from being produced.

That is, when the magnesium vibrating plate 12 is prepared to a final dimension by cutting the outer periphery or the like, by dispensing with the end face treatment for rust proofing, the magnesium vibrating plate 12 can immediately be shifted to a step of bonding the edge 13 (insert molding step) and productivity can be promoted by reducing operating steps.

In the vibrating plate for a speaker and the method of fabricating the same according to the invention, a structure of the magnesium vibrating plate is not limited to the cone type shown in the first embodiment but can also be constituted by, for example, a dome type as shown by a second embodiment described below.

### Second Embodiment

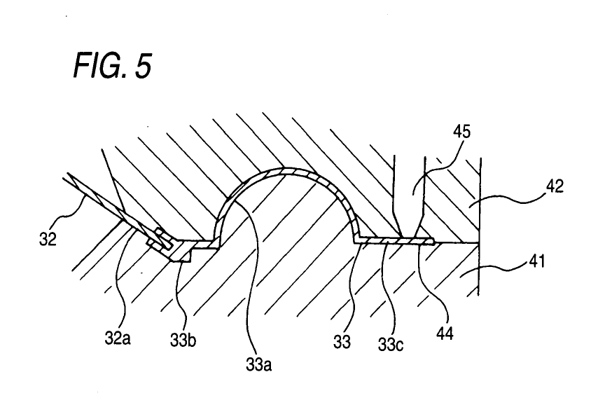

FIG. 4 is a vertical sectional view of a speaker apparatus using a vibrating plate for a speaker of a second embodiment according to the invention, and FIG. 5 shows a state of forming an edge of the vibrating plate for a speaker shown in FIG. 4 by insert molding.

A speaker apparatus 31 shown in FIG. 4 is provided with a vibrating plate 34 for a speaker bonding an edge 33 comprising resin thereof to an outer periphery of a magnesium vibrating plate 32 of a dome type, the voice coil bobbin 15 in the cylindrical shape connected to an outer peripheral edge of the magnesium vibrating plate 32, the voice coil 16 wound around the outer periphery of the voice coil bobbin 15, the magnetic circuit 18 formed with the magnetic gap 17 for containing the voice coil 16, and the frame 19 for supporting the magnetic circuit 18 and the vibrating plate 32.

According to the edge 33, an inner peripheral edge 33b extended to an inner diameter portion of a loop portion 33a constituting a damper for permitting an amplitude of the magnesium vibrating plate 32 constitutes a portion of bonding to an outer peripheral edge of the magnesium vibrating plate 32, and an outer peripheral edge 33c extended to an outer diameter side of the loop portion 33a is fixed to the edge supporting portion 19a of the frame 19.

A structure in which the inner peripheral edge 33b of the edge 33 is provided with a pinching groove 33d which is the outer peripheral edge of the magnesium vibrating plate 32 is brought into close contact with and fitted to is common to that of the case of the above-described embodiment of the cone type.

The edge 33 is molded at a predetermined shape by injection molding of a resin and in that occasion, as shown by FIG. 5, the edge 33 is formed integrally with the magnesium vibrating plate 32 by insert molding of constituting a state of holding the outer peripheral edge 32a of the magnesium vibrating plate 32 which has been cut to a predetermined dimension into a cavity 44 formed by up and lower dies 41, 42 for molding the edge and injecting the resin into the cavity 24.

Notation 45 of FIG. 5 designates a runner (resin introducing port) for guiding the resin into the cavity 24.

Also in the case of the second embodiment, the magnesium vibrating plate 32 is delivered to a resin molding step of executing insert molding of the edge 33 for integral molding with the edge 33 in a state in which a cut face of an outer periphery thereof is not subjected to an end face treatment for rust proofing after cutting the outer periphery to a predetermined dimension.

According to the magnesium vibrating plate 32, a method of fabricating a magnesium thin plate constituting a raw material and a fabricating condition, a surface treatment of forming an anodized film formed at a surface of the magnesium thin plate for promoting rust proofing of magnesium and design performance may be common to those in the case of the above-described first embodiment and an explanation thereof will be omitted according to the embodiment.

As described above, even when the magnesium vibrating plate 32 is of the dome type, by integrally forming the edge 33 to the magnesium vibrating plate 32 by insert molding shown in FIG. 5 in the structure having the pinching groove 33d which the inner peripheral edge 33b of the edge 33 for bonding with the outer peripheral edge of the magnesium vibrating plate 32 is brought into close contact with and fitted to the outer peripheral edge 32a of the magnesium vibrating plate 32, operation and effect similar to those of the first embodiment can be achieved.

That is, since an adhering agent is not used for bonding the edge 33 to the magnesium vibrating plate 32, there is not brought about a situation of evaporating a volatile organic compound in an adhering agent and influence on an operator and contamination of an environment caused by evaporating a volatile organic compound can be prevented.

When the magnesium vibrating plate 32 is prepared to a final dimension by cutting the outer periphery or the like, by dispensing with an end face treatment for rust proofing, the magnesium vibrating plate 32 can be shifted to a step of bonding the edge 33 (insert molding step) and productivity can be promoted by reducing operating steps.

1. A vibrating plate for a speaker, comprising:
a magnesium vibrating plate whose major component is magnesium; and
an edge comprising a resin in which an inner peripheral edge of the edge is bonded to an outer peripheral edge of the magnesium vibrating plate for attaching the magnesium vibrating plate to a frame,
wherein the inner peripheral edge of the edge is constituted by a structure having a pinching groove which the outer peripheral edge of the magnesium vibrating plate is brought into close contact with and fitted to, and
the edge is formed integrally with the magnesium vibrating plate by insert molding.

2. A method for fabricating a vibrating plate for a speaker including a magnesium vibrating plate whose major component is magnesium; and an edge comprising a resin in which an inner peripheral edge of the edge is bonded to an outer peripheral edge of the magnesium vibrating plate for attaching the magnesium vibrating plate to a frame, comprising:
forming the edge integrally with the magnesium vibrating plate by insert molding,
wherein the inner peripheral edge of the edge is constituted by a structure having a pinching groove which the outer peripheral edge of the magnesium vibrating plate is brought into close contact with and fitted to.

3. The method according to claim 2, wherein the magnesium vibrating plate is delivered to a place of the insert molding of the edge after cutting an outer periphery of the magnesium vibrating plate to a predetermined dimension and in a state of not subjecting a cut face of the outer periphery of the magnesium vibrating plate to an end face treatment for rust proofing.
